(19) United States
(12) Patent Application Publication
(10) Pub. No.: US 2012/0189161 A1
(43) Pub. Date: Jul. 26, 2012

(54) VISUAL ATTENTION APPARATUS AND CONTROL METHOD BASED ON MIND AWARENESS AND DISPLAY APPARATUS USING THE VISUAL ATTENTION APPARATUS

(75) Inventors: Seok Bae Chang, Daejeon (KR); Chang Hyun Park, Gyeonggi-do (KR); Sung Won Sohn, Daejeon (KR)

(73) Assignee: ELECTRONICS AND TELECOMMUNICATIONS RESEARCH INSTITUTE, Daejeon (KR)

(21) Appl. No.: 13/347,866

(22) Filed: Jan. 11, 2012

(30) Foreign Application Priority Data
Jan. 25, 2011 (KR) 10-2011-0007368

(51) Int. Cl. G06K 9/00

(52) U.S. Cl. 382/103

(57) ABSTRACT

Disclosed are a visual attention apparatus based on mind awareness and an image output apparatus using the same. Exemplary embodiments of the present invention can reduce data throughput by performing object segmentation and context analysis according to downsampling and colors and approximate shapes of input images so as to detect attention regions using extrinsic visual attention and intrinsic visual attention. In addition, the exemplary embodiments of the present invention can detect the attention regions having different viewpoints for each user by detecting the attention regions due to the extrinsic visual attention and the intrinsic visual attention and processing and displaying the attention regions as various regions of interest, thereby increasing the image immersion and the utility of contents.

### CROSS-REFERENCES TO RELATED APPLICATIONS

The present application claims priority under 35 U.S.C 119(a) to Korean Application No. 10-2011-0007368, filed on Jan. 25, 2011, in the Korean Intellectual Property Office, which is incorporated herein by reference in its entirety set forth in full.

### BACKGROUND

Exemplary embodiments of the present invention relate to a visual attention apparatus and a control method based on mind awareness and an image output apparatus using the same, and more particularly, to a visual attention apparatus and a control method based on mind awareness and an image output apparatus using the same capability of detecting attention regions by converging extrinsic visual attention inherent to an image with intrinsic visual attention based on mind awareness and displaying images having different viewpoints for each user according to the detected attention regions.

The most used of human sensory organs is a sight. Since sight can help intuitive understanding faster than other senses, a need thereof has been increased with the development of computer technologies and the increase in complex functions.

In recent years, the development of communication and memory technologies lowered many barriers of video data transfer. As a result, a need for a solution using a sight, in particular, an analysis of visual attention and a use thereof has been increased.

Visual attention is a very important characteristic that serve to supplement limited information processing capability of a human in terms of sight among senses. However, due to an incomplete visual system, a visual attention system also has several disadvantages.

Examples of disadvantages in terms of the visual attention may include situations such as inattentive blindness when paying less attention to some objects while more attention on others, change blindness that does not notice change generated for a short period of time due to a temporal and spatial blank generated in the visual system, retrogress suppression that suppresses attention to scenes seen once, negative priming that suppresses attention to scenes arousing negative emotion, or the like.

The visual attention system may filter unnecessary matters so as to perform efficient processing due to the limited information processing capability of a human but may serve as disadvantages in many businesses to be visually processed among businesses of modern society.

The above-mentioned technology means a background art of the technology field to which the present invention belongs rather than meaning the related art.

### SUMMARY

An object of the present invention is to provide a visual attention apparatus and a control method based on mind awareness capable of detecting attention regions by converging extrinsic visual attention inherent to an image with intrinsic visual attention based on mind awareness.

Another object of the present invention is to provide a visual attention apparatus and a control method based on mind awareness capable of reducing data throughput by performing object segmentation and context analysis according to downsampling and colors and approximate shapes of input images so as to detect attention regions using extrinsic visual attention and intrinsic visual attention.

Another object of the present invention is to provide an image output apparatus using a visual attention apparatus based on mind awareness capable of displaying images having different viewpoints for each user.

An embodiment of the present invention relates to a visual attention apparatus based on mind away, including: a preprocessor downsampling input images to perform filtering, object segmentation, and context analysis; a context collection unit collecting context information for context recognition; a memory storage unit storing context information collected in the context collection unit and favorable impressions of the context information with the objects; a visual attention processor receiving the filtered images from the preprocessor, the segmented objects, and the context analysis results to collect data from the input images through an extrinsic visual attention model and an intrinsic visual attention model due to command words and the context information and favorable impression stored in the memory storage unit, thereby setting an extrinsic attention region and an intrinsic attention region; and a visual attention decision unit deciding the attention regions for the extrinsic attention regions and the intrinsic attention regions set in the visual attention processor according to a decision rule.

The memory storage unit may include: a short-term storage unit storing the collected context information; and a long-term storage unit storing the favorable impressions with objects.

The context information may include a purpose, a position, time, user emotion information, social network information, web search information, and shopping information.

The user emotion information may include information on a user and the expression, voice, and brain wave of a user.

The extrinsic visual attention model may include: a feature map generator generating a feature map of colors, brightness, and directivity for the filtered images; a saliency map generator generating a saliency map based on the feature map; and an extrinsic attention region setting unit setting an extrinsic attention region based on the saliency map.

The intrinsic visual attention model may include: an object recognition unit recognizing the objects segmented in the preprocessor to label each object; a mind awareness unit establishing favorable impressions with the objects by performing text mining on the context information stored in the memory storage unit and the objects labeled in the object recognition unit and storing the favorable impressions in the memory storage unit; a command controller setting correlation with the objects labeled in the object recognition unit according to command instructions; and an intrinsic attention region setting unit setting the intrinsic attention region through the favorable impression established in the mind awareness unit and the correlation set in the command controller.

Application of the extrinsic visual attention model may be decided according to the decision rule in the visual attention decision unit.

The decision rule may be decided by a priority according to a risk related object, an unexpected object, a unique object, a purpose, and a preference.

Another embodiment of the present invention relates to a control method of a visual attention apparatus based on mind awareness, comprising: collecting context information for context recognition; performing downsampling on input images; filtering the downsampled images and then performing object segmentation and context analysis; collecting data from the input images through an extrinsic visual attention model and an intrinsic visual attention model due to the filtered images, the segmented objects, the context analysis results, command words, and the context information to set attention regions; and deciding the attention regions for the set attention regions according to a decision rule.

The context information may include a purpose, a position, time, user emotion information, social network information, web search information, and shopping information.

The user emotion information may include information on a user and an expression, a voice, and a brain wave of a user.

The decision rule may be decided by priority according to a risk related object, an unexpected object, a unique object, a purpose, and a preference.

Another embodiment of the present invention relates to an image output apparatus using a visual attention apparatus, comprising: a user input unit inputting context information including user emotion information; a visual attention apparatus detecting attention regions for input images based on the user emotion information and the context information input through the user input unit; and an image processor processing images for the input images, displaying the processed images on a display, processing the attention regions detected in the visual attention apparatus as an image of interest and displaying the processed attention regions on the display.

The attention regions may be subjected to zoom-in processing when being processed as an image of interest in the image processor.

The attention regions may be subjected to blinking processing when being processed as an image of interest in the image processor.

The image output apparatus may further include a storage unit storing the input images and a plurality of interest images corresponding to the plurality of attention regions corresponding to the input images.

An image of interest corresponding to the attention regions may be read from the storage unit and are processed when being processed as the interest regions in the image processor.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram illustrating a configuration for the visual attention apparatus based on mind awareness according to an embodiment of the present invention;

FIG. 2 is a flow chart for describing a control method of the visual attention apparatus based on mind awareness according to the embodiment of the present invention; and

FIG. 3 is a block diagram illustrating a configuration for the image output apparatus using the visual attention apparatus according to the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

In describing the embodiment, a thickness of lines illustrated in the drawings, a size of components, etc., may be exaggeratedly illustrated for clearness and convenience of explanation. In addition, terms described to be below are terms defined in consideration of functions in the present invention, which may be changed according to the intention or practice of a user or an operator. Therefore, these terms will be defined based on contents throughout the specification.

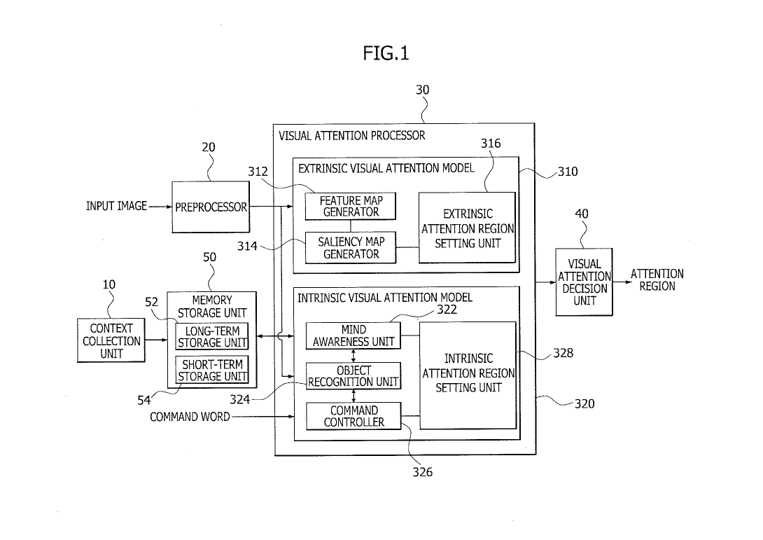

FIG. 1 is a block diagram illustrating a configuration for the visual attention apparatus based on mind awareness according to an embodiment of the present invention.

As illustrated in FIG. 1, a visual attention apparatus based on mind awareness according to the embodiment of the present invention includes a context collection unit 10, a memory storage unit 50, a preprocessor 20, a visual attention processor 30, and a visual attention decision unit 40.

The context collection unit 10 collects context information for situational recognition.

An example of the context information may include a purpose, a position, time, user emotion information, social network information, web search information, and shopping information. Further, the context information may include extrinsic visual attention information that may be detected by characteristics inherent to images, such as a color, a shape, a size, a direction, inequality, or the like.

In addition, the context information may include intrinsic visual attention information that may catch favorable impression or unfavorable impression based on information on a user and user emotion information including an expression, a voice, and a brain wave of a user so as to catch intention of user's mind and may catch personal information of interest and emotional actions to various contexts through social network information, web search information, and shopping information.

Among the context information, the purpose is the uppermost model and a combination of the purpose and other contexts affects an intrinsic visual attention model 320.

The intrinsic visual attention model 320 is built using an algorithm such as case based reasoning (CBR), or the like, to decide categorization for each context and appropriate actions.

The memory storage unit 50 stores the context information in the context collection unit 10 and favorable impression of context information with objects. In this case, a short-term storage unit of the memory storage unit 50 is collected and stored with keywords of web search of a user as usual, keywords used at the time of using the social network, favorable impression related words, and keywords used at the time of web shopping in a context collection unit for current works. In addition, a long-term storage unit stores favorable impression with an object so as to process implicit favorable impression.

The preprocessor 20 performs filtering, object segmentation, and context analysis and downsampling input images, thereby reducing data throughput.

That is, the visual attention may mean that a human roughly sees images to find important things. Accordingly, the visual attention, which instantly catches general atmosphere without deep analysis of the images, performs a very low level of visual processing function, such that the images processed by the visual attention is very low in minuteness but provide information enough to catch risk factors and rough atmosphere at a very rapid speed.

Therefore, the preprocessor 20 segments objects such as things, persons, animals, or the like, and analyzes contexts through the context information or a color, a shape, and a relative size by downsampling the input images.

The downsampling deletes odd or even rows/columns of an original image or deletes values according to the context information to reduce an amount of data.

For example, in order to estimate location category through the context analysis, when recognizing the position and time of the input images based on the position and time information detected through a GPS, it may expect the images appropriate for the corresponding locations. That is, when recognizing information on downtown, buildings, persons, roads, or the like, may be estimated by the sizes or the colors of images even when the input images have low resolution.

On the other hand, when the position and time information cannot be recognized by the GPS, the concept of the general input images may be estimated through the colors, the approximate shapes, and the relative sizes.

For example, a background modeling method previously creates models for the colors or the shapes for each designated location category and estimates the location categories according to whether the models are matched.

The visual attention processor 30 receives the filtered images, the segmented objects, the context analysis results from the preprocessor 20 to collect data from the input images through an extrinsic visual attention model 310 and the intrinsic visual attention model 320 due to command words and the context information and the favorable impression stored in the memory storage unit to set extrinsic attention regions and intrinsic attention regions.

In this case, the extrinsic visual attention model 310 includes a feature map generator 312, a saliency map generator 314, and an extrinsic attention region setting unit 316.

The feature map generator 312 generates a feature map of colors, brightness, and directivity for the images filtered in the preprocessor 20.

The saliency map generator 314 generates a saliency map of a distinct region based on the feature map.

The extrinsic attention region setting unit 316 sets the extrinsic attention regions based on the saliency map.

As descried above, the extrinsic visual attention model 310 collects from the input images data for the salient region by the features such as colors, brightness, directivity, or the like, which are inherent to the images, as factors attracting user attention, thereby setting the extrinsic attention region.

The intrinsic visual attention model 320 includes an object recognition unit 324, a mind awareness unit 322, a command controller 326, and an intrinsic attention area setting unit 328.

The object recognition unit 324 recognizes objects which are object-segmented in the preprocessor 20 to perform labeling on each object.

The mind away unit 322 sets the favorable impression with the objects by performing text mining on the context information in the short-term storage unit 54 of the memory storage unit 50 in which the context information collected through the context collection unit 10 is stored and the objects labeled in the object recognition unit 324 so as to be stored in the long-term storage unit 52 of the memory storage unit 50, thereby setting the objects having the high favorable impression as the intrinsic attention region when performing the implicit intrinscity.

The command controller 326 sets the correlation with the objects labeled in the object recognition unit 324 with respect to the objects given according to the command words, thereby setting the object having the strong correlation as the intrinsic attention region.

The intrinsic attention region setting unit 328 sets the intrinsic attention region through the favorable impression set in the mind awareness unit 322 and the correlation set in the command controller 326.

When the objects are explicitly input through the command words in order to set the intrinsic attention region in the intrinsic visual attention model 320, the command controller 326 compares the correlation with the objects labeled in the object recognition unit 324 to decide how strong the correlation with the commands is, thereby selecting the suitable objects.

For example, when the purpose is ‘finding subway’ and the current position is ‘road A’ through the GPS information, if ‘representing subway’ is proposed as the related object, the intrinsic visual attention model 320 may find an object ‘representing subway’ among the input images to set the found region as the intrinsic attention region that is a region of interest (ROI).

In addition, when processing the implicit intrincity for setting the intrinsic attention regions, the objects having the high favorable impression are selected by comparing the favorable impression with the objects stored in the long-term storage unit 52 through the text mining between the keywords for finding the attention regions collected through the context collection unit 10 and the objects recognized in the object recognition unit 324.

The visual attention decision unit 40 decides the attention regions according to the decision rule of the extrinsic attention regions and the intrinsic attention regions set in the visual attention processor 30.

In this case, the influence of the extrinsic attention regions is decided by the extrinsic visual attention model 310 according to the decision rule.

The decision rule for deciding the attention regions may be proposed as various types of algorithms. However, among those, concepts that need to be included in a vital role are a ‘priority’ concept, for example, priority of ‘attention’ may be configured in an order of 1. risk related object, 2. unexpected object, 3. unique object, 4. purpose, 5. preference, or the like, which may be changed by experimental results or personal difference.

As described above, the visual attention apparatus based on mind awareness segments objects by performing the downsampling on the input images in the preprocessor 20 based on the context information input through the context collection unit 10 reducing the data throughput to segment the objects and analyze the contexts, detect the extrinsic attention regions and the intrinsic attention regions due to the extrinsic visual attention model 310 and the intrinsic visual attention model 320 in the visual attention processor 30, and then, decide and display the attention regions according to the decision rule in the visual attention decision unit 40.

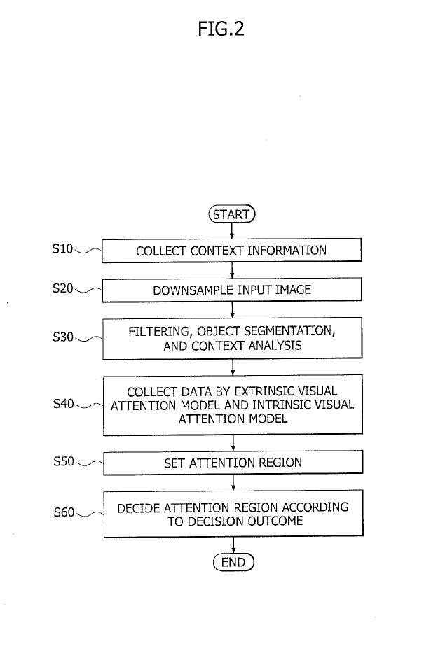

FIG. 2 is a flow chart for describing a control method of the visual attention apparatus based on mind awareness in accordance with the embodiment of the present invention.

As illustrated in FIG. 2, the control method of the visual attention apparatus based on mind awareness collects the context information for situational recognition so as to set the intrinsic attention regions through the context collection unit 10 (S10).

In this case, an example of the context information may include a purpose, a position, time, user emotion information, social network information, web search information, and shopping information. Further, an example of the context information may include the extrinsic visual attention that may be detected by characteristics inherent to images, such as the color, the shape, the size, the direction, the inequality, or the like.

In addition, the context information may include the intrinsic visual attention that may catch favorable impression or unfavorable impression based on information on a user and user emotion information including an expression, a voice, and a brain wave of a user so as to catch intention of user's mind and may catch personal information of interest and emotional actions to various contexts through social network information, web search information, and shopping information.

Thereafter, the downsampling is performed so as to reduce the data throughput for the input images in the preprocessor 20 (S20).

The downsampling deletes odd or even rows/columns of an original image or deletes values in accordance with the context information to reduce an amount of data.

As described above, various filtering, the object segmentation, and the context analysis are performed on the downsampled images (S30).

For example, in order to estimate location category through the context analysis, when recognizing the position and time of the input images based on the position and time information detected through a GPS, it may expect the images appropriate for the corresponding locations. That is, when recognizing information on downtown, buildings, persons, roads, or the like, may be estimated by the sizes or the colors of images even when the input images have low resolution.

On the other hand, when the position and time information cannot be recognized by the GPS, the concept of the general input images may be estimated through the colors, the approximate shapes, and the relative sizes.

The visual attention processor 30 collects data from the input images by the data mining method through the extrinsic visual attention model and the intrinsic visual attention model due to the segmented objects and the context-analyzed context information in the images filtered in the preprocessor 20 to set the attention regions (S40) (S50).

In this case, the intrinsic visual attention model is built based on the algorithm such as the case based reasoning (CBR), or the like, to decide the categorization and actions for each context with reference to the purpose in the context information.

For example, in the case in which the set attention regions set the purpose as the objects appropriate for the context, when the current position is caught through the GPS, the related object is proposed and the intrinsic visual attention model 320 finds the related objects in the input images to set the regions as the intrinsic attention region that is the region of interest (ROI).

The visual attention decision unit 40 for the extrinsic attention region and the intrinsic attention region set as described above decides the attention regions in accordance with the decision rule (S60).

The decision rule may be proposed as various types of algorithms. However, among those, concepts that need to be included in a vital role are the ‘priority’ concept, for example, priority of ‘attention’ may be configured in an order of the risk related object, the unexpected object, the unique object, the purpose, the preference, or the like, which may be changed by experimental results or personal difference.

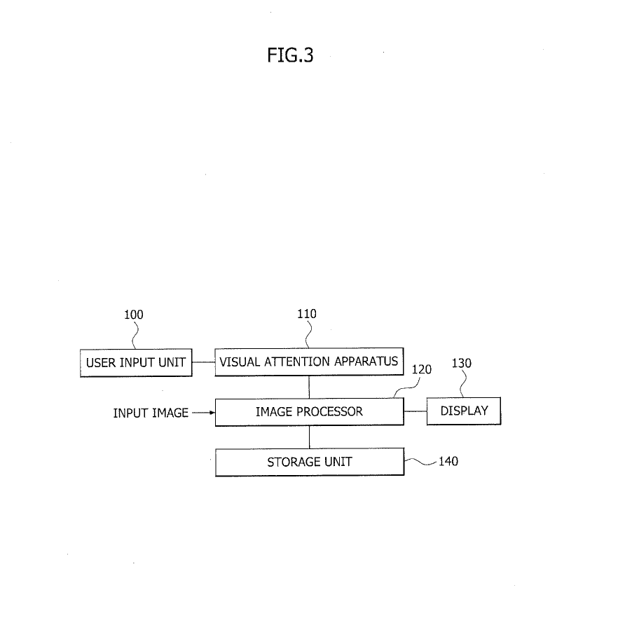

FIG. 3 is a block diagram illustrating a configuration for the image output apparatus using the visual attention apparatus in accordance with the embodiment of the present invention.

As illustrated in FIG. 3, the image output apparatus using the visual attention apparatus relates to the image output apparatus providing the attention regions and the corresponding interest images when detecting the attention regions including the user emotion information through the visual attention apparatus.

To this end, the image output apparatus using the visual attention apparatus includes a user input unit 100, a visual attention apparatus 110, and an image processor 120.

The user input unit 100 receives the context information including the emotion information for each user.

In this configuration, an example of the context information may include the purpose, the position, the user emotion information, the social network information, the web search information, and the shopping information.

An example of the context information includes the extrinsic visual attention that may be detected by the characteristics inherent to the images, such as the colors, the shapes, the sizes, the directions, the equability, or the like.

In addition, the context information may include intrinsic visual attention information that may catch favorable impression or unfavorable impression based on information on a user and user emotion information including an expression, a voice, and a brain wave of a user so as to catch intention of user's mind and may catch personal information of interest and emotional actions to various contexts through social network information, web search information, and shopping information.

The visual attention apparatus 110 detects the attention regions for the input images based on the user emotion information and the context information input through the user input unit 100.

The visual attention apparatus 110 preprocesses the input images based on the user emotion information and the context information input through the user input unit 100 and downsamples the preprocessed input images and then, segments the objects and analyzes the context and then, collects the data from the input images by the data mining method through the extrinsic visual attention model and the intrinsic visual attention model due to the context information therefor to set the attention regions and decide and display the attention region according to the decision rule.

The image processor 120 processes the images for the input images and displays the processed images on the display 130 and processes the attention regions detected in the visual attention apparatus 110 as the region of interest and displays the processed attention regions on the display 130.

In this case, when the attention regions are processed as the region of interest in the image processor 120, the attention regions may be subjected to zoom-in processing to be represented in detail. The attention regions are subjected to blinking processing to warn the traffic conditions or the abnormal conditions as the attention regions during the vehicle driving or in connection with the plurality of input images such as the warning CCTV, or the like, to decide the risk conditions at the time of driving or warning, thereby warning the attention regions to a driver or a manger so as to be recognized.

In addition, when additionally including the storage unit 140 that stores the input images and the plurality of interest images corresponding to the plurality of attention regions corresponding to the input images, an image of interest corresponding to the attention regions detected in the visual attention apparatus 110 are read from the storage unit 140 so as to be displayed on the image processor 120 using 3D or augmented reality, or the like, thereby increasing the reality and maximizing the image immersion. In addition, when being applied to learning contents or entertainment contents, an image of interest for the attention regions are independently displayed according to each user, thereby increasing the learning capability and incurring the interest.

In this case, if a plurality of cameras (not illustrated) photographing the input images are installed and are provided so as to perform the photographing in various viewpoints such that the photographed images are provided through the cameras corresponding to the attention regions detected in the visual attention apparatus 110 and are processed in the image processor 120, the attention regions for players or talents to which the users pay attention during sports games or performance are set, thereby providing the images through the movement of the cameras along the corresponding players and talents.

As set forth above, the exemplary embodiments of the present invention can reduce the data throughput by performing the object segmentation and the context analysis according to the downsampling and the colors and approximate shapes of the input images so as to detect the attention regions using the extrinsic visual attention and the intrinsic visual attention.

In addition, the exemplary embodiments of the present invention can detect the attention regions having different viewpoints for each user by detecting the attention regions due to the extrinsic visual attention and the intrinsic visual attention and processing and displaying the attention regions as various regions of interest, thereby increasing the image immersion and the utility of contents.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A visual attention apparatus based on mind awareness, comprising:
a preprocessor downsampling input images to perform filtering, object segmentation, and context analysis;
a context collection unit collecting context information for context recognition;
a memory storage unit storing context information collected in the context collection unit and favorable impressions of the context information with the objects;
a visual attention processor receiving the filtered images from the preprocessor, the segmented objects, and the context analysis results to collect data from the input images through an extrinsic visual attention model and an intrinsic visual attention model due to command words and the context information and favorable impression stored in the memory storage unit, thereby setting an extrinsic attention region and an intrinsic attention region; and
a visual attention decision unit deciding the attention regions for the extrinsic attention regions and the intrinsic attention regions set in the visual attention processor according to a decision rule.

2. The visual attention apparatus of claim 1, wherein the memory storage unit includes:
a short-term storage unit storing the collected context information; and
a long-term storage unit storing the favorable impressions with objects.

3. The visual attention apparatus of claim 1, wherein the context information includes a purpose, a position, time, user emotion information, social network information, web search information, and shopping information.

4. The visual attention apparatus of claim 3, wherein the user emotion information includes information on a user and the expression, voice, and brain wave of a user.

5. The visual attention apparatus of claim 1, wherein the extrinsic visual attention model includes:
a feature map generator generating a feature map of colors, brightness, and directivity for the filtered images;
a saliency map generator generating a saliency map based on the feature map; and
an extrinsic attention region setting unit setting an extrinsic attention region based on the saliency map.

6. The visual attention apparatus of claim 1, wherein the intrinsic visual attention model includes:
an object recognition unit recognizing the objects segmented in the preprocessor to label each object;
a mind awareness unit establishing favorable impressions with the objects by performing text mining on the context information stored in the memory storage unit and the objects labeled in the object recognition unit and storing the favorable impressions in the memory storage unit;
a command controller setting correlation with the objects labeled in the object recognition unit according to command instructions; and
an intrinsic attention region setting unit setting the intrinsic attention region through the favorable impression established in the mind awareness unit and the correlation set in the command controller.

7. The visual attention apparatus of claim 1, wherein application of the extrinsic visual attention model is decided according to the decision rule in the visual attention decision unit.

8. The visual attention apparatus of claim 7, wherein the decision rule is decided by a priority according to a risk related object, an unexpected object, a unique object, a purpose, and a preference.

9. A control method of a visual attention apparatus based on mind awareness, comprising:
collecting context information for context recognition;
performing downsampling on input images;
filtering the downsampled images and then performing object segmentation and context analysis;
collecting data from the input images through an extrinsic visual attention model and an intrinsic visual attention model due to the filtered images, the segmented objects, the context analysis results, command words, and the context information to set attention regions; and
deciding the attention regions for the set attention regions according to a decision rule.

10. The control method of claim 9, wherein the context information includes a purpose, a position, time, user emotion information, social network information, web search information, and shopping information.

11. The control method of claim 10, wherein the user emotion information includes information on a user and an expression, a voice, and a brain wave of a user.

12. The control method of claim 9, wherein the decision rule is decided by priority according to a risk related object, an unexpected object, a unique object, a purpose, and a preference.

13. An image output apparatus using a visual attention apparatus, comprising:
a user input unit inputting context information including user emotion information;
a visual attention apparatus detecting attention regions for input images based on the user emotion information and the context information input through the user input unit; and
an image processor processing images for the input images, displaying the processed images on a display, processing the attention regions detected in the visual attention apparatus as an image of interest and displaying the processed attention regions on the display.

14. The image output apparatus of claim 13, wherein the attention regions are subjected to zoom-in processing when being processed as an image of interest in the image processor.

15. The image output apparatus of claim 13, wherein the attention regions are subjected to blinking processing when being processed as an image of interest in the image processor.

16. The image output apparatus of claim 13, further comprising a storage unit storing the input images and a plurality of interest images corresponding to the plurality of attention regions corresponding to the input images.

17. The image output apparatus of claim 16, wherein an image of interest corresponding to the attention regions are read from the storage unit and are processed when being processed as the interest regions in the image processor.
